(19) United States
(12) Patent Application Publication
(10) Pub. No.: US 2019/0176386 A1
(43) Pub. Date: Jun. 13, 2019

(54) EMBOSSING TOOL AND METHOD TO MINIMISE BUBBLE FORMATION IN EMBOSSED STRUCTURES

(71) Applicant: CCL Secure Pty Ltd., Craigieburn, Victoria (AU)

(72) Inventors: Karlo Ivan Jolic, Craigieburn, Victoria (AU); Ben Paul Stevens, Craigieburn, Victoria (AU); Gary Fairless Power, Craigieburn, Victoria (AU)

(73) Assignee: CCL Secure Pty Ltd., Craigieburn, Victoria (AT)

(21) Appl. No.: 16/325,589

(22) PCT Filed: Aug. 15, 2017
(86) PCT No.: PCT/AU2017/050866

§ 371 Date: Feb. 14, 2019

(30) Foreign Application Priority Data
Aug. 15, 2016 (AU) 2016101452

(51) Int. Cl. B29C 59/04; B29C 59/02; B31F 1/07; B42D 25/324; B42D 25/425

(52) U.S. Cl. CPC B29C 59/04; B29C 59/022; B31F 1/07; B29L 2011/0016; B42D 25/425; B29C 2059/023; B42D 25/324

(57) ABSTRACT

An embossing tool for use with a rotating embossing roller, including: a tool body having a tool surface; and an array of recesses set into the tool surface to form a desired embossing surface profile, wherein at least two of the recesses are interconnected by a passage to enable fluid communication therebetween during embossing.

### TECHNICAL FIELD

The present invention relates to an embossing tool and method of embossing fine structures. The invention is suitable for use in the manufacture of micro-optic devices used as a security device for bank notes and coins, credit cards, cheques, passports, identity cards and the like, and it will be convenient to describe the invention in relation to that exemplary, non-limiting application.

### BACKGROUND OF THE INVENTION

It is well known that many of the world's bank notes as well as other security documents include security devices which produce optical effects enabling a visual authentication of the bank note. Some of the security devices include micro lenses which act to sample and magnify micro-imagery elements and project imagery which is observable by a user.

In some cases, it is known to form the micro-lenses and/or micro-imagery elements on a substrate by embossing. One example is the “soft emboss” process used by the Applicant. This “soft emboss” process is a roll-to-roll process that involves embossing one or both of micro-lenses and micro-imagery elements on a substrate formed from the application of a layer of UV curable lacquer directly onto a transparent polymer web. The applied UV curable lacquer is embossed by placing the moving web in contact with a rotating embossing roller. The lacquer is sandwiched between the embossing tool or shim forming part of or affixed to the roller and the web, so that under impression pressure, the lacquer fills the recessed structures in the embossing tool. While the lacquer is still in contact with the embossing tool and under impression pressure, the UV curable lacquer is cured by UV radiation directed through the transparent polymer web.

In such a process, the micro-lenses and imagery structures can contain bubbles. When magnified, for example under moire magnification, the bubbles can lead to undesirable defects or artefacts in the image projected to the user of the micro-optic device. In particular, in the case of an imagery design that consists of repeating patterns of micro-icons, that are designed to be magnified in a moire-magnifying micro-lens type security feature, the bubbles can often appear in repeating locations. This means that the bubbles themselves are magnified and notably degrade the projected optical image effect seen by the user of the micro-optic device.

The appearance of bubbles or voids is also problematic in applications where the embossed structures are micro-lenses of a bank note security feature. Bubbles or voids in micro-lenses will compromise the imaging function of each micro-lens, and therefore degrade the quality of the projected optical effect image.

Bubbles or voids in micro-lenses will also compromise the appearance of the surface of the micro-lens security feature, particularly when viewed in shallow incidence reflected light. The bubbles or voids will manifest as timely defects on the surface of the feature, once again leading to a perception of poor quality.

It would be desirable to provide an embossing tool, a micro-optic device formed using an embossing tool and a process for forming a micro-optic device using an embossing tool that reduces or eliminates the incidence of bubbles or voids being formed in embossed structures.

It would also be desirable to provide a micro-optic device and method for its manufacture that ameliorates or overcomes one or more disadvantages or inconveniences of known micro-optic devices.

### SUMMARY OF INVENTION

One aspect of the invention provides an embossing tool for use with an embossing roller, the embossing tool including: a tool body having a tool surface; and an array of recesses set into the tool surface to form a desired embossing surface profile, wherein at least two of the recesses are interconnected by a passage to enable fluid communication therebetween during embossing.

In one form, the embossing roller is a rotating embossing roller.

In one or more embodiments, the passage or passages are aligned with the direction of embossing roller rotation or movement.

In one or more embodiments, each recess in the array of recesses is connected to another recess in the array by a passage to enable fluid communication therebetween during embossing.

In one or more embodiments, all recesses are connected to another recess by a passage to enable fluid communication therebetween during embossing.

In one or more embodiments, the embossing surface profile corresponds to a two-dimensional array of micro-lenses forming part of a micro-optic device.

In one or more embodiments, the embossing surface profile corresponds to a two-dimensional array of micro-imagery elements forming part of a micro-optic device.

Another aspect of the invention provides a micro-optic device formed using an embossing tool as described hereabove, including a transparent substrate; one or both of: an array of micro-imagery elements forming a micro-imagery structure on a first side of the substrate, and an array of micro-lenses on a second side of the substrate that image the micro-imagery elements on the first side of the substrate to form an imagery viewable by a viewer; and filled passages interconnecting at least two of the micro-imagery elements and/or two of the micro-lenses.

In one or more embodiments, the filled passages and the micro-lenses are offset by a random or non-constant amount to avoid the passages being imaged by the micro-lenses.

In one or more embodiments, the micro-imagery elements form one or more of repeating icons, integral imagery and interlaced imagery.

In one or more embodiments, the micro-lenses are hexagonal packed and/or rectangular packed.

In one or more embodiments, the substrate includes: a transparent layer; and a UV-curable lacquer applied to the transparent layer, wherein the UV-curable lacquer is cured by UV radiation during embossing.

Another aspect of the invention provides a security document including a micro-optic device as described hereabove as a security feature.

Another aspect of the invention provides a process for forming a micro-optic device as described hereabove, including the step of using a rotating embossing roller to apply the embossing tool to the substrate to form (a) one or both of the array of micro-imagery elements forming a micro-imagery structure on a first side of the substrate, and the array of micro-lenses on a second side of the substrate that image the micro-imagery on the first side of the substrate to form an imagery viewable by a viewer; and (b) the filled passages.

Another aspect of the invention provides a process for forming a micro-optic device as described hereabove, including forming the substrate by applying the UV-curable lacquer applied to the UV-transparent layer; using a rotating embossing roller to apply the embossing tool to the UV-curable lacquer; and curing the UV-curable lacquer by UV radiation during embossing to form (a) one or both of the array of micro-imagery elements forming a micro-imagery structure on a first side of the substrate, and the array of micro-lenses on a second side of the substrate that sample and magnify the micro-imagery on the first side of the substrate; and (b) the filled passages.

### Definitions

### Security Document or Token

As used herein, the terms security documents and tokens includes all types of documents and tokens of value and identification documents including, but not limited to the following: items of currency such as bank notes and coins, credit cards, cheques, passports, identity cards, securities and share certificates, driver's licences, deeds of title, travel documents such as airline and train tickets, entrance cards and tickets, birth, death and marriage certificates, and academic transcripts.

The invention is particularly, but not exclusively, applicable to security devices, for authenticating items, documents or tokens, such as bank notes, or identification documents, such as Identity cards or passports, formed from a substrate to which one or more layers of printing are applied.

More broadly, the invention is applicable to a micro-optic device which, in various embodiments, is suitable for visual enhancement of clothing, skin products, documents, printed matter, manufactured goods, merchandising systems, packaging, point of purchase displays, publications, advertising devices, sporting goods, security documents and tokens, financial documents and transaction cards, and other goods.

### Security Device or Feature

As used herein, the term security device or feature includes any one of a large number of security devices, elements or features intending to protect security document or token from counterfeiting, copying, alteration or tampering. Security devices or features may be provided in or on the substrate of the security document or in or on one or more layers applied to the base substrate, and may take a wide variety of forms such as security threads embedded in layers of the security document; security inks such as fluorescent, luminescent or phosphorescent inks, metallic inks, iridescent inks, photochromic, thermochromic, hydrochromic, or peizochromic inks; printed or embossed features including release structures; interference layers; liquid crystal devices; lenses and lenticular structures; optically variable devices (OVDs) such as diffractive devices including diffraction gradients, holograms and diffractive optical elements (DOEs).

### Substrate

As used herein, the term substrate refers to the base material from which the security document or token is formed. The base material may be paper or other fibrous materials such as cellulous; a plastic or polymeric material including but not limited to polypropylene (PP), polyethylene (PE), polycarbonate (PC), polyvinyl chloride (PVC), polyethylene terephthalate (PET), biaxially-oriented polypropylene (BOPP); or a composite material of two or more materials, such as a laminate of paper and at least one plastic material, or of two or more polymeric materials.

### Transparent Windows and Half Windows

As used herein, the term window refers to a transparent or translucent area in the security document compared to the opaque region to which printing is applied. The window maybe fully transparent so as to allow the transmission of light substantially unaffected, or it may be partly transparent or translucent, partly allowing the transmission of light but without allowing objects to be seen clearly through the window area.

A window area may be formed in a polymeric security document which has at least one layer of transparent polymeric material and one or more opacifying layers applied to at least one side of a transparent polymeric substrate, by omitting at least one opacifying layer in the region forming the window area. If opacifying layers are applied to both sides of a transparent substrate, a fully transparent window may be formed by omitting the opacifying layers on both sides of the transparent substrate in the window area.

A partly transparent or translucent area herein after referred to as a “half-window”, may be formed in a polymeric security document which has opacifying layers on both sides by omitting the opacifying layers on one side only of the security document in the window area so that “half-window” is not fully transparent but allows sunlight to pass through without allowing objects to be viewed clearly through the half-window.

Alternatively, it is possible for the substrates to be formed from a substantially opaque material, such as paper or fibrous material, without an insert of transparent plastics material inserted into a cut out or recessed into the paper or fibrous substrate to form a transparent window or a translucent half-window area.

### Opacifying Layers

One or more opacifying layers may be applied to a transparent substrate to increase the opacity of the security document. An opacifying layer is such that L_{T}<Lₒ where Lₒ is the amount of light incident on the document, and L_{T} is the amount of light transmitted through the document. An opacifying layer may comprise any one or more of a variety of opacifying coatings. For example, the opacifying coatings may comprise a pigment, such as titanium dioxide, dispersed within a binder or carrier of heat-activated cross-linkable polymeric material. Alternatively, a substrate of transparent plastic material could be sandwiched between opacifying layers of paper or other partially or substantially opaque material to which indicia may be subsequently printed or otherwise applied.

### UV-Curable Lacquer

As used herein, the term UV-curable lacquer is intended to include, by way of non-limiting example, a lacquer consisting of monomers and photo-initiator dispersed in a liquid. Exposure to ultraviolet radiation will cause such monomers to undergo radical chain growth polymerisation, turning the liquid into a solid.

### BRIEF DESCRIPTION OF DRAWINGS

Preferred embodiments of the invention will now be described by way of example only with reference to the accompanying drawings in which:

FIG. 1 is schematic diagram of one embodiment of an apparatus for in-line manufacturing part of a security document;

FIG. 2 is a cut away side view of a partially manufactured security document manufactured by the apparatus shown in FIG. 1;

FIG. 3 is an isometric view of a known embossing tool used to manufacture the security document shown in FIG. 2;

FIG. 4 is an isometric view of a first embodiment of an embossing tool according to the present invention;

FIG. 5 is an isometric view of a two dimensional array of micro lenses embossed by the embossing tool shown in FIG. 4;

FIG. 6 is an isometric view of a second embodiment of an embossing tool according to the present invention;

FIG. 7 is an isometric view of a two dimensional array of micro lenses embossed using the embossing tool of FIG. 6;

FIG. 8 is an isometric view of a micro optic device including micro lenses and micro imagery elements formed on opposite sides of a substrate;

FIG. 9 is an isometric view of the micro-optic device shown in FIG. 8 and in addition showing imagery projected to a user;

FIG. 10 is a plan view of the micro imagery elements of the micro-optic device of FIG. 8;

FIGS. 11 and 12 are isometric views of the top and bottom of a micro-optic device including an integrated micro lens and micro imagery structure formed by embossing on both sides of the device substrate; and

FIG. 13 is an isometric view of the micro-optic device shown in FIGS. 11 and 12 and additionally depicting imagery projected to a user from both sides of the micro-optic device.

### DETAILED DESCRIPTION OF DRAWINGS

Embossable ink generally refers to any ink, lacquer, or other coating which may be applied to a suitable substrate in a printing process, and which is embossed while soft to form a desirable relief structure and subsequently cured to retain the relief structure created during the embossing process. The curing process can take place either after embossing or at substantially the same time as the embossing step. Such embossable ink can be cured by radiation such as ultraviolet (UV) radiation, electron beams, X-rays, or heat, chemicals, or any combination of these. Exemplary embodiments of the present invention will now be described using a UV curable lacquer as the embossable ink, but it should be appreciated that other alternative types of embossable inks may also be used.

With some polymeric substrates, it may be necessary or desirable to apply an intermediate layer to the substrate before the embossable ink is applied to the substrate and embossed, to improve the adhesion of the embossed structure formed on the substrate. Such intermediate layer is generally known as an adhesion promotion layer. For some substrates, an adhesion promotion layer may not be required and the embossable ink may be applied directly onto the substrate.

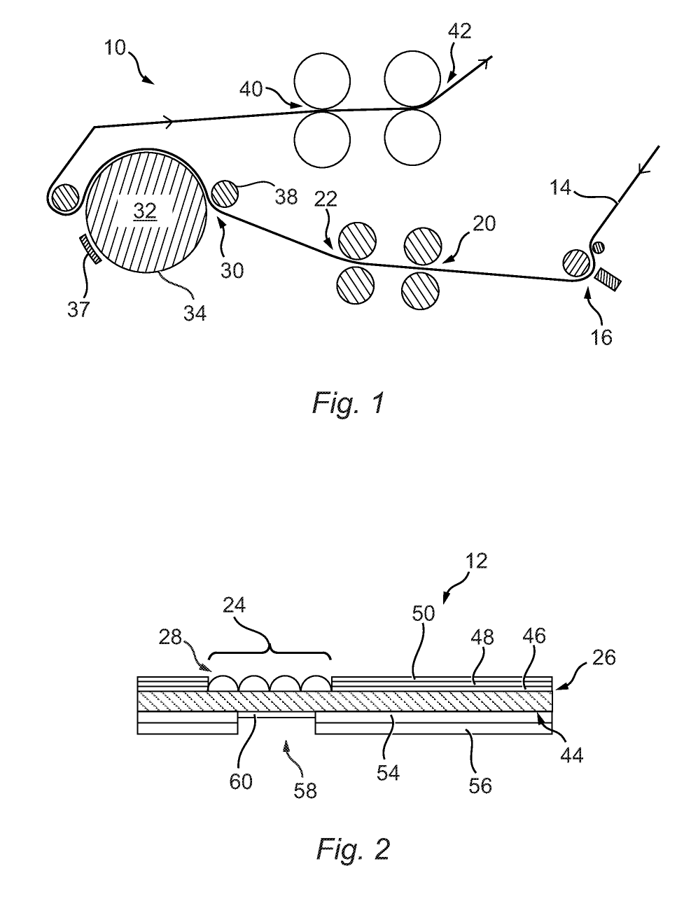

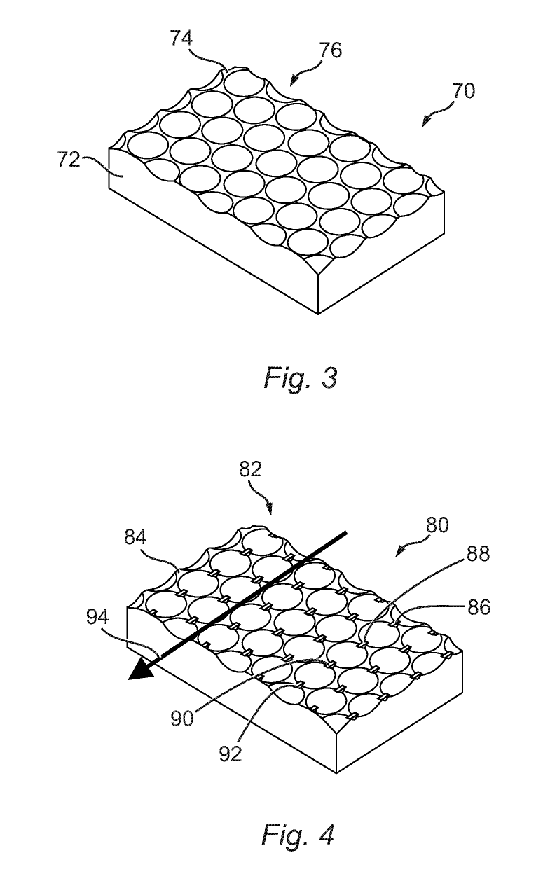

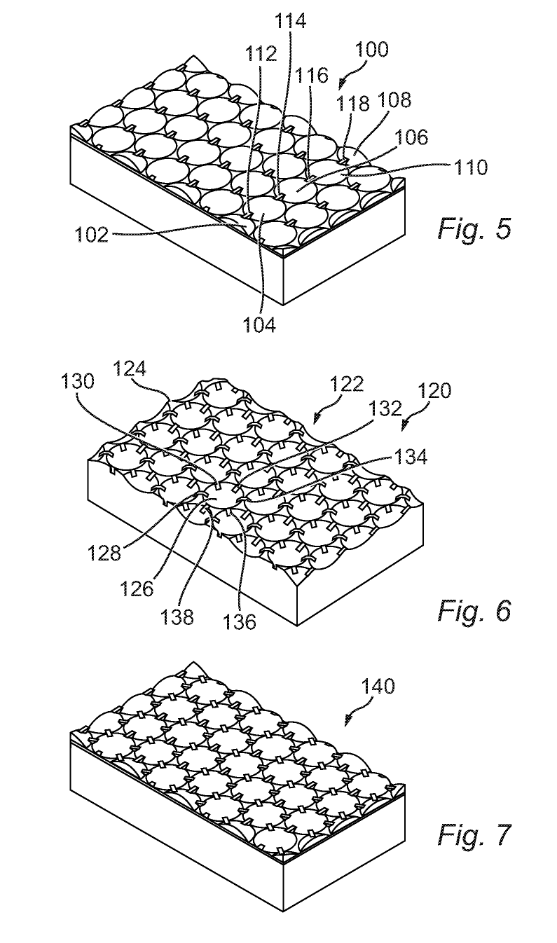

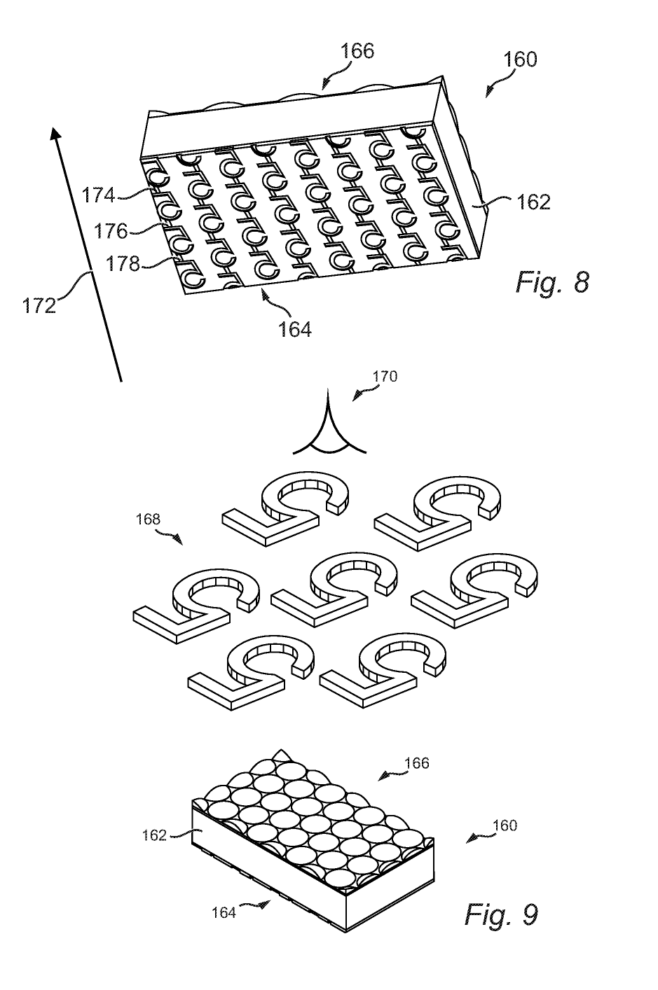

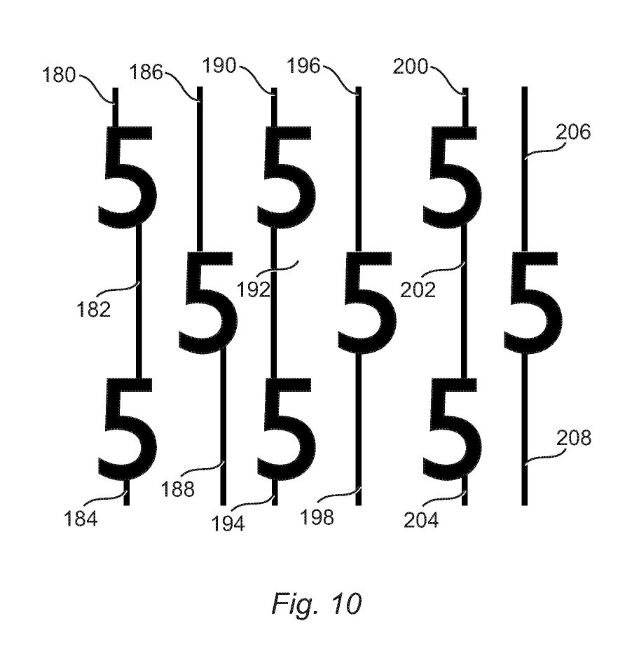

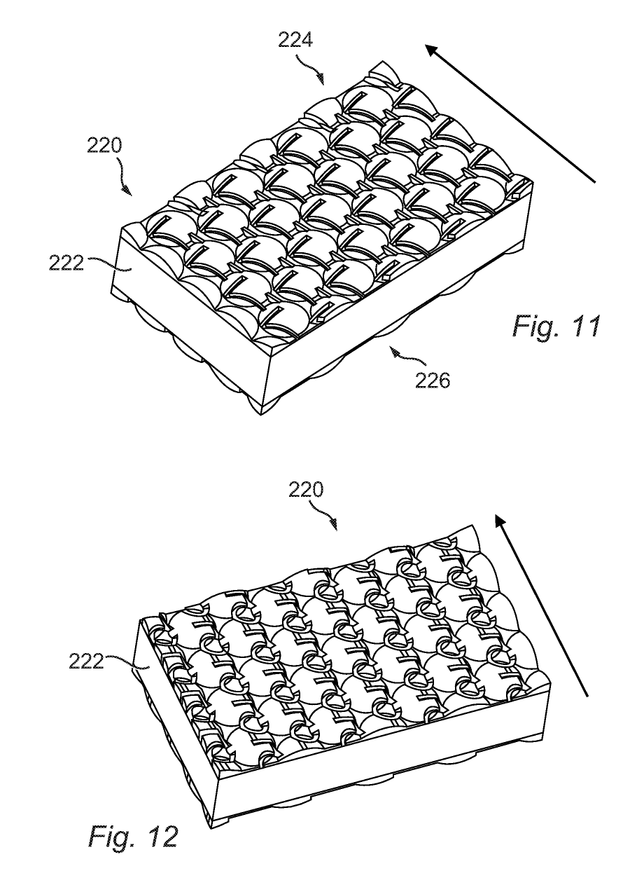

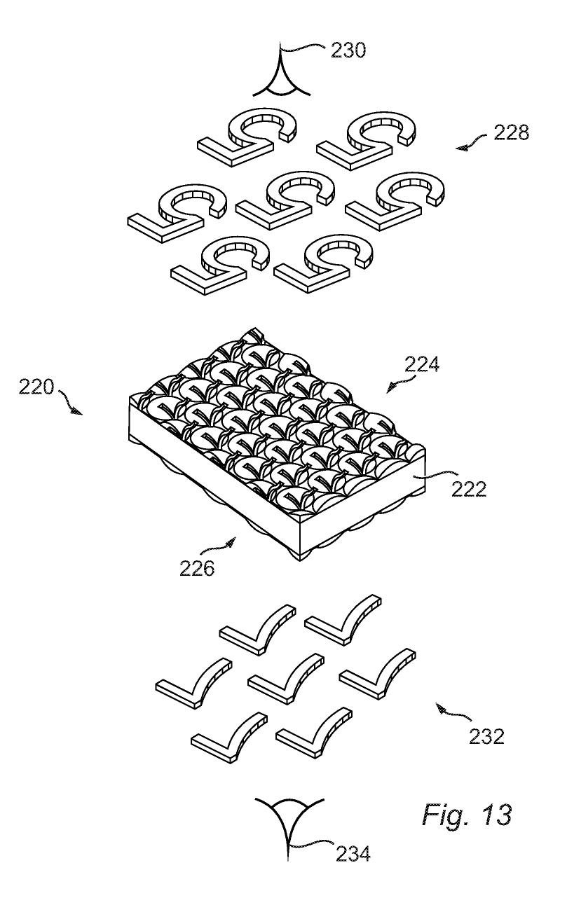

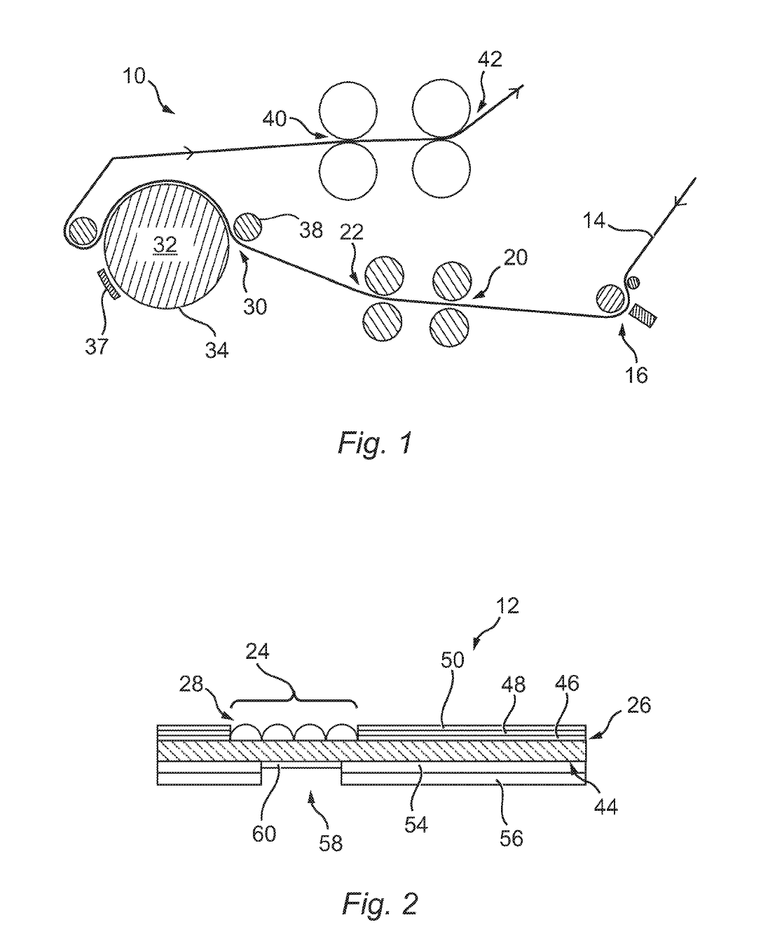

FIG. 1 shows an exemplary apparatus 10 for in-line manufacturing part of an exemplary document 12 shown in FIG. 2 and which includes an adhesion promotion layer as mentioned above. A continuous web 14 of translucent or transparent material such as polypropylene or PET is subject to an adhesion promoting process at a first processing station 16 including a roller assembly. Suitable adhesion promoting processes are flame treatment, corona discharge treatment, plasma treatment or similar.

The adhesion promoting layer is applied at a second processing station 20 including a roller assembly. A suitable adhesion promoting layer is one specifically adapted for the promotion of adhesion of UV-curable coatings to polymeric surfaces. The adhesion promoting layer may have a UV-curing layer, a solvent-based layer, a water-layer or any combination of these.

At a third processing station 22 which also includes a roller assembly, an embossable ink coating is applied to the surface of the adhesion promoting layer. The embossable ink can be applied via flexographic printing, gravure printing or a silk screen printing process and variations thereof amongst other printing processes.

In the embodiment shown in FIG. 2, the embossable ink is only applied to a security element area 24 on a first surface 26 of the security document 12 where a structure 28 is formed. The structure 28 can include micro-imagery elements forming a micro-imagery structure and/or micro-lenses which will be collectively referred to as micro-optic structures herein. The security element area 24 can take the form of a strip, a discrete patch in the form of a simple geometric shape or a more complex geographical design.

While the embossable ink is still, at least partially, liquid, or soft, it is processed to form the structure 28 at a fourth processing station 30. In one embodiment, the processing station 30 includes an embossing roller 32 for embossing a micro-optic structure, such as the structure 28, into the embossable ink which in this example is provided in the form of a UV-curable lacquer. The cylindrical embossing surface 34 has surface relief formations corresponding to the shape of the structure 28 to be formed. In one embodiment, the surface relief formations can orient the array of micro-imagery elements and/or array of micro-lenses in the machine direction (that is, in the direction of roller rotation), transverse to the machine direction, or in multiple directions at an angle to the machine direction. The apparatus 10 can form micro-lenses and micro-imagery elements in a variety of two-dimensional or three-dimensional shapes.

The cylindrical embossing surface 34 of the embossing roller 32 may have a repeating pattern of surface relief formations or the relief structure formations may be localised to individual shapes corresponding to the shape of the security element area 24. The embossing roller 32 may have the surface relief formations formed by a diamond stylus of appropriate cross section, or by direct laser engraving, or by chemical etching, or the surface relief formations may be provided by at least one embossing shim 37 provided on the embossing roller 32. The embossing shim 37 or shims may be attached via adhesive tape, magnetic tape, clamps or other appropriate mounting techniques.

In the context of the present specification, the phrase “embossing tool” is intended to embrace both the surface relief formations formed on the embossing surface 34 of the embossing roller 32 and an embossing shim 37 that may be affixed to the embossing roller 32.

The UV-curable lacquer on the web 14 is brought into contact with the cylindrical embossing surface 34 by an embossing tool roller 38 at the processing station 30 such that the liquid or soft UV-curable lacquer flows into the surface relief formations of the cylindrical embossing surface 34 or the embossing shim 37. At this stage, the UV-curable lacquer is exposed to UV radiation, for example, by transmission through the web 14 to thereby cure the UV-curable lacquer to fix the relief structure formed by the embossing surface 34 and/or the embossing shim 37.

With the structure 28 now applied to the web 14, one or more additional layers are applied at some downstream processing stations 40 and 42. The additional layers may be clear or pigmented coatings and applied as partial coating, as a contiguous coating or a combination of both. In one preferred method, the additional layers are opacifying layers which are applied to one or both surfaces of the web 14 except in the region of this structure 28.

FIG. 2 shows a partially manufactured document 12 formed by the apparatus shown in FIG. 1, including an embossed structure 28 including an array of micro-optic structures such as micro-imagery elements and/or micro-lenses. The document 12 comprises a transparent substrate of polymeric material, preferable a biaxially-orientated polypropylene (BOPP) having a first surface 26 and a second surface 44. Opacifying layers 46, 48 and 50 are applied to the first surface 26, except in the security element area 24. Opacifying layer 54 and 56 are applied to the second surface 44 except in a window area 58. The window area 58 substantially coincides with the security element area 24 on the first surface 26. A printed layer 60 may be applied to the second surface 44 in the window area 58.

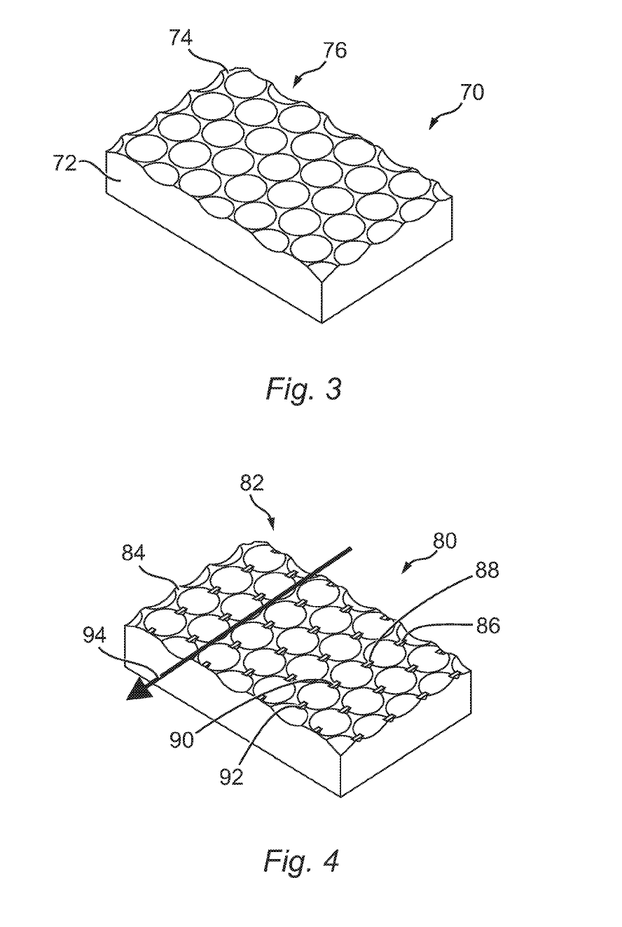

FIG. 3 depicts an example of a known embossing tool 70. The embossing tool 70 includes a tool body 72 having a tool surface 74 into which is set an array of recesses 76 to form a desired embossing surface profile. In the example depicted in FIG. 3, the recesses 76 form a conventional two dimensional array of hexagonally packed concave recesses suitable for embossing a two dimensional array of hexagonally packed spherical convex micro lenses. As an example, the width of each micro lens can be 54 microns and the depth is 12 microns. Each recess 76 is a closed structure separated from adjacent recesses 76. The closed structure of each recess increases the likelihood that bubbles will be formed when the embossing tool 70 is used in a roll-to-roll soft emboss process such as that described above with reference to FIG. 1.

Investigations by the Applicant have determined that during the embossing process, as the UV curable lacquer is squeezed in between the polymer web 14 and the embossing tool roller 38, UV curable lacquer is pressed into the closed recessed areas 76. During this process, the air present inside the recessed closed areas 76 cannot escape completely. This means that not all of the volume of the recessed closed structure 76 is filled with UV curable lacquer. That portion that is unfilled manifests as a bubble/void in the final cured structure.

If the embossing tool design consists of a repeating pattern of icons, as is typically the case in moire magnification type designs, and these icons include recessed closed areas, then the bubbles produced tend to be in consistent locations in each icon. This means that the bubbles themselves will be moire magnified by the lenses of the security feature, that is, the bubbles will be clearly visible to a user of the moire magnification design, resulting in a perception of poor quality. A moire magnification design is often employed as a security feature in a security document such as bank notes, ID cards, or cheques. For this reason, it is advantageous to minimise or eliminate the occurrence of such bubbles in the UV embossed imagery structures of moire magnifying security features.

FIG. 4 depicts an example of an embossing tool 80 that addresses this issue by interconnecting at least two of the array of recesses 82 set into the tool surface 84 by a passage to enable fluid communication therebetween during embossing. Providing such passages 86, 88, 90, 92 enables air present in the recesses 82 to escape during embossing. In the example shown in FIG. 4, all recesses 82 in the array of recesses 82 are connected to another recess by a passage to enable fluid communication therebetween during embossing. The passages, such as those referenced 86, 88, 90, 92 are aligned with the machine direction 94, or in other words the direction of rotation of the embossing roller 32. In this way, the recessed structures in the embossing tool 80 can be completely filled with UV curable lacquer because air is able to be squeezed out of each recess via the passages 86, 88, 90, 92, as the lacquer is pressed into the recessed areas of the embossing tool 80 during embossing, that is, there are no voids or bubbles which are produced.

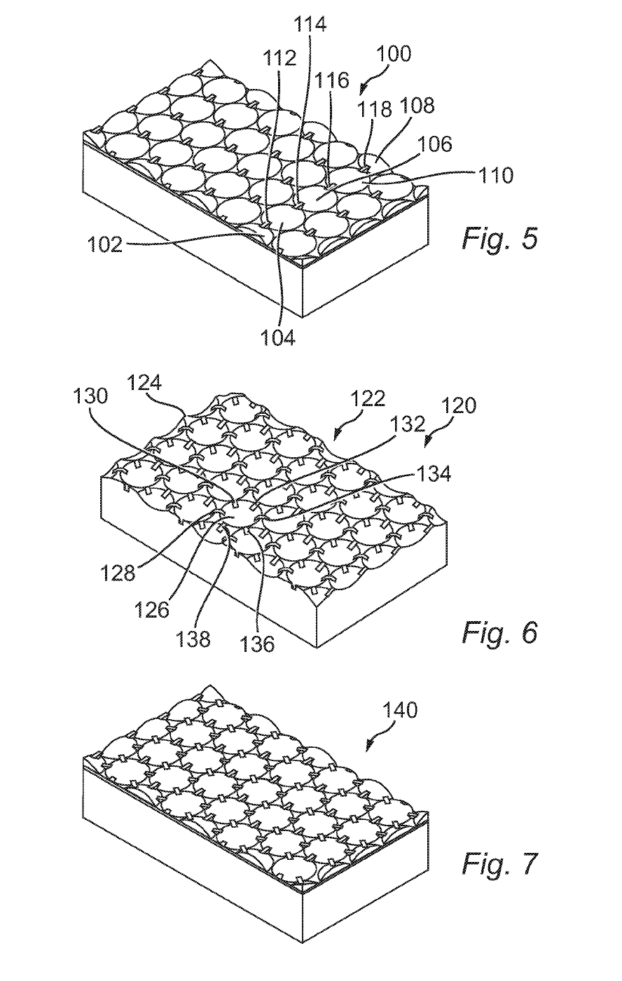

FIG. 5 depicts an array 100 of micro lenses formed using the exemplary embossing tool 80. The passages 86, 88, 90, 92 formed between recesses 82 in the embossing tool 80 cause the creation of corresponding filled passages interconnecting adjacent micro lenses. For example, micro lenses 102, 104, 106, 108 and 110 are respectively interconnected by filled passages 112, 114, 116 and 118.

In the case of an array of micro lenses forming a part of a micro optic device used in bank notes or other security documents, the passages may typically have dimensions of 7 microns wide by 5 microns deep, and may optionally include tapered side walls. It can be seen from FIGS. 4 and 5 that each micro lens has two passages that connect it to two adjacent micro lenses in the machine direction. The interconnecting channels ensure that recessed areas that are aligned in the machine direction are in fluid communication with each other, thereby allowing air trapped in the embossing tool to be squeezed out during the embossing process.

The introduction of filled passages between micro lenses in the array 100 of micro lenses results in a percentage of the imaging surface of each lens being lost, thereby resulting in the image contrast being proportionally reduced. However, it has been found that the percentage lost in image contrast is small so that the quality of optical effect image remains acceptable.

FIG. 6 depicts another embodiment of an embossing tool 120 identical to the embossing tool 80 in that it includes an array 122 of recesses set into a tool surface 124. However, in this embodiment, passages are provided between each recess and each immediately adjacent recess to optimise the flow of air and/or lacquer between recesses during embossing. By way of example, the recess 126 is connected to each of the six immediately adjacent recesses by six passages 128, 130, 132, 134, 136 and 138. It will be understood however that increasing the number of passages interconnecting each recess to adjacent recesses to improve fluid flow therebetween will have the corresponding effect of proportionally reducing image contrast. A balance must be achieved between the consequent reduction in the quality of the optical effect image produced and the fluid flow during embossing that may be required to minimise or eliminate the occurrence of bubbles or voids in the micro lens structure.

FIG. 7 depicts an embossed micro lens structure 140 made using the embossing tool 120. The trade-off once again is that a percentage of the imaging surface of each micro lens has been lost, so that the image contrast will be proportionally reduced by a greater amount than the example shown in FIG. 5 which has fewer channels per lens.

Whilst the embossing tool and embossed structures depicted in FIGS. 3 to 7 relate to a micro lens structure it will be appreciated that the embossing surface profile resulting from the setting of an array of recesses into the embossing tool surface can be used to generate a two dimensional array of micro lenses forming part of a micro optic device but can also be used to produce a two dimensional array of micro imagery elements forming part of a micro optic device.

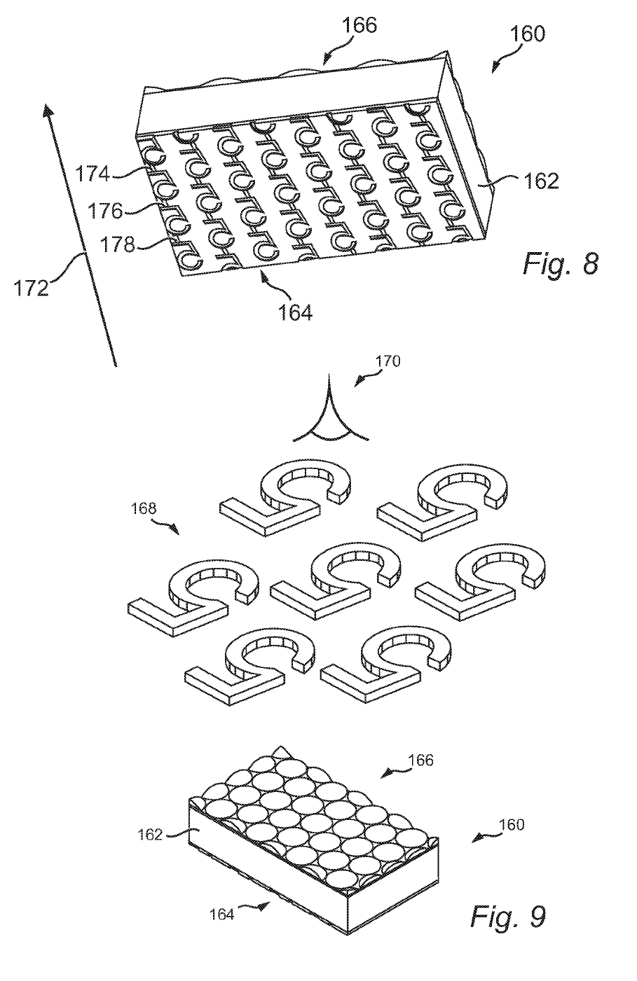

FIGS. 8 and 9 depict one example of a micro optic device 160 including a transparent substrate 162, a two dimensional array of micro imagery elements 164 on a first side of the substrate 162 and a two dimensional array of micro lenses 166 on a second side of the substrate 162 that sample and magnify the micro imagery 164 on the first side of the substrate. FIG. 9 depicts imagery 168 that is produced by the micro optic device 160 for observation by a user from a viewing position 170. The imagery produced is a magnified moire type design, and the image elements consist of an array of “icons” of the numeral “5” corresponding to the array of micro imagery elements forming the micro imagery structure 164 on the first side of the substrate 162.

In this example, the micro imagery elements (i.e. the “icons” in the form of the numeral “5”) are embossed onto the first side of the substrate 162 such that the background of the numeral “5” is recessed into the surface. Passages aligned with the machine direction 172 interconnecting recesses on the embossing tool have resulted in the embossed micro imagery elements being interconnected by filled passages, such as those referenced 174, 176, 178 in order to minimise or eliminate the production of voids or bubbles in the micro imagery elements that are embossed.

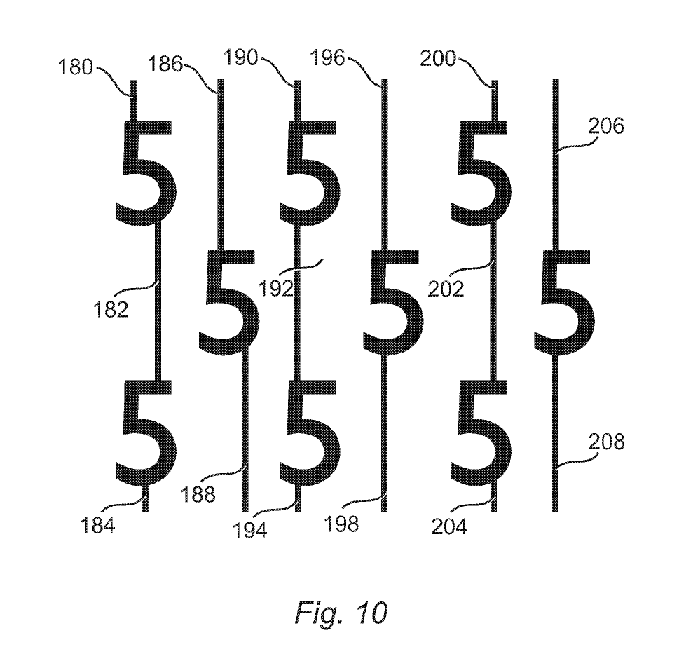

Preferably, the passages added can be located so that they are not moire magnified by the micro lenses 166 of the micro optic device 160. As can be seen in FIG. 10, the passages 180, 182, 186, 188, 190, 192, 194, 196, 198, 200, 202, 204, 206, 208 are located so that the phase offset between the passages 180 and 208 and the array 166 of micro lenses is random or non-constant.

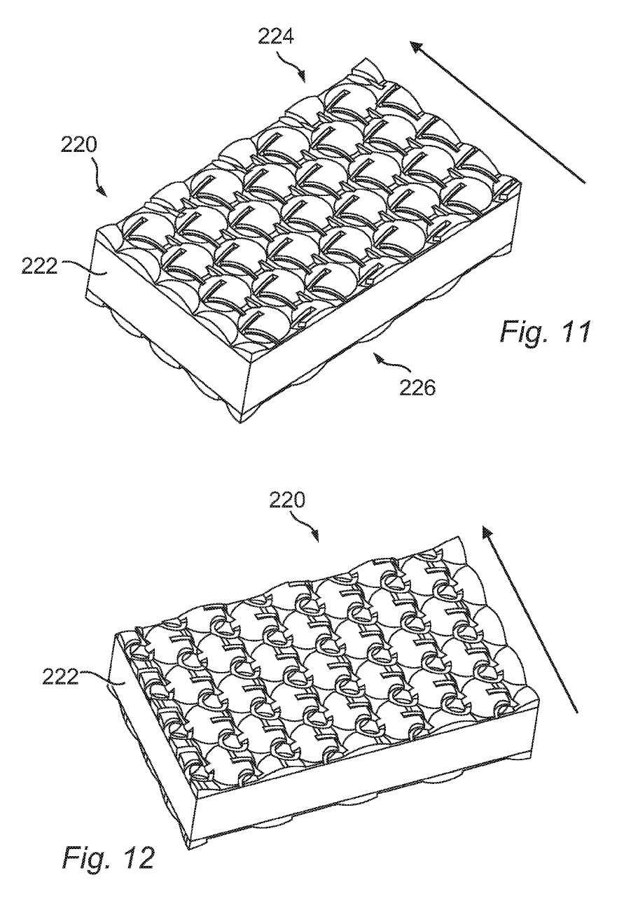

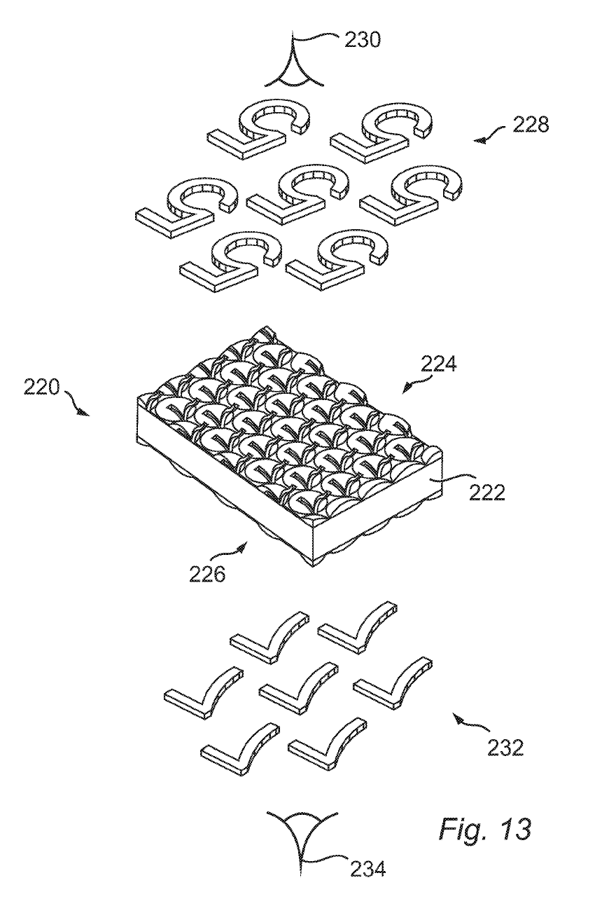

FIGS. 11 to 13 depict another embodiment of a micro optic device 220 that includes a transparent substrate 222. An integrated structure 224 of micro imagery elements and micro lenses is formed on a first side of the substrate 222 and a second unitary structure 226 of micro imagery elements and micro lenses is formed on a second side of the substrate 222. Micro lenses from one side of the substrate 222 act to sample and magnify micro imagery elements on the other side of the substrate 222. Imagery 228 produced by moire magnification of the micro imagery elements on a first side of the substrate 222 is viewable from a first viewing position 230, whereas imagery 232 resulting from moire magnification of the micro imagery elements on a second side of the substrate is viewable from a viewing position 234.

In FIG. 11 the micro imagery shown consists of an array of the numeral “7” wherein each element of the array is recessed below the lens surface. In FIG. 12 the micro imagery shown consists of an array of the numeral “5” wherein each element of the array protrudes above the lens surface.

As can been seen from FIGS. 11 and 12, passages interconnecting recesses on an embossing tool used to create the unitary structures on both sides of the substrate 222 have resulted in filled passages interconnecting the micro imagery and micro lens elements respectively in the machine direction on both sides of the substrate 222. Once again, where passages interconnect micro imagery and micro lens elements respectively forming a micro imagery and a micro lens structure, the phase offset of the lenses on one side relative to the passages on the other side may be random or non-constant in order to minimise the moire magnification of the passages by the lenses on their opposite side.

Where the term “comprise”, “comprises”, “comprised” or “comprising” are used in the specification (including the claims) they are intended to be interpreted as specifying the presence of the stated features, integers, steps or components, but not precluding the presence of one or more other features, integers, steps or components or group thereof.

It will be understood that the invention is not limited to the specific embodiments described herein, which are provided by way of example only. The scope of the invention is as defined by the claims appended hereto.

1. An embossing tool for use with an embossing roller to form micro-optic security devices, the embossing tool including:
a tool body having a tool surface; and
an array of recesses set into the tool surface to form a desired embossing surface profile, wherein
at least two of the recesses are interconnected by a passage to enable fluid communication therebetween during embossing.

2. An embossing tool according to claim 1, wherein
the passage or passages are aligned with the direction of embossing roller rotation or movement.

3. An embossing tool according to claim 1, wherein
each recess in the array of recesses is connected to another recess in the array by a passage to enable fluid communication therebetween during embossing.

4. An embossing tool according to claim 1, wherein
the embossing surface profile corresponds to a two-dimensional array of micro-lenses forming part of a micro-optic security device.

5. An embossing tool according to claim 1, wherein
the embossing surface profile corresponds to a two-dimensional array of micro-imagery elements forming part of a micro-optic security device.

6. A micro-optic security device formed using an embossing tool according to claim 1, including
a transparent substrate;
one or both of:
an array of micro-imagery elements forming a micro-imagery structure on a first side of the substrate, and
an array of micro-lenses on a second side of the substrate that image the micro-imagery elements on the first side of the substrate to form an imagery viewable by a viewer; and
filled passages interconnecting at least two of the micro-imagery elements and/or two of the micro-lenses.

7. A micro-optic security device according to claim 6,
wherein the filled passages and the micro-lenses are offset by a random or non-constant amount to avoid the passages being imaged by the micro-lenses.

8. A micro-optic security device according to claim 6, wherein the micro-imagery elements form one or more of repeating icons, integral imagery and interlaced imagery.

9. A micro-optic security device according to claim 6, wherein
the micro-lenses are hexagonal packed and/or rectangular packed.

10. A micro-optic security device according to claim 6, wherein the substrate includes:
a transparent layer; and
a UV-curable lacquer applied to the transparent layer, wherein
the UV-curable lacquer is cured by UV radiation during or after embossing.

11. A security document including a micro-optic security device according to any claim 6 as a security feature.

12. A process for forming a micro-optic security device according to claim 6, including the step of:
using a rotating embossing roller to apply the embossing tool to the substrate to form
(a) one or both of the array of micro-imagery elements forming a micro-imagery structure on a first side of the substrate, and the array of micro-lenses on a second side of the substrate that image the micro-imagery on the first side of the substrate to form an imagery viewable by a viewer; and
(b) the filled passages.

13. A process for forming a micro-optic device according to claim 12, including
forming the substrate by applying the UV-curable lacquer to the transparent layer;
using a rotating embossing roller to apply the embossing tool to the UV-curable lacquer; and
curing the UV-curable lacquer by UV radiation during embossing to form
(a) one or both of the array of micro-imagery elements forming a micro-imagery structure on a first side of the substrate, and the array of micro-lenses on a second side of the substrate that image the micro-imagery on the first side of the substrate to form an imagery viewable by a viewer; and
(b) the filled passages.
